(19) United States
(12) Patent Application Publication
(10) Pub. No.: US 2004/0090895 A1
(43) Pub. Date: May 13, 2004

(54) Apparatus, method, and medium including computer readable code for discriminating recording medium type

(75) Inventors: Young-Woo Lee, Gyeonggi-do (KR); Sang-Whook Kim, Gangwon-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-city (KR)

(21) Appl. No.: 10/673,143

(22) Filed: Sep. 30, 2003

(30) Foreign Application Priority Data
Nov. 12, 2002 (KR) 2002-70060

(51) Int. Cl. G11B 7/00

(52) U.S. Cl. 369/53.22

(57) ABSTRACT

An apparatus, method, and medium including computer readable code for discriminating a type of a recording medium using an amplitude of a groove wobble formed on the recording medium. The apparatus includes a radio frequency (RF) amplifier, a wobble amplitude detector, and a system controller. The RF amplifier generates a signal based on light reflected from the recording medium, wobble amplitude detector detects the amplitude of wobble formed on the recording medium based on an output signal of the RF amplifier, and the system controller discriminates a type of the recording medium by comparing the wobble amplitude detected by the wobble amplitude detector with a reference value.

### CROSS-REFERENCE TO RELATED APPLICATIONS

This application claims the benefit of Korean Patent Application No. 2002-70060, filed on Nov. 12, 2002, in the Korean Intellectual Property Office, the disclosure of which is incorporated herein by reference.

### BACKGROUND OF THE INVENTION

1. Field of the Invention

The present invention relates to an apparatus, method, and medium including computer readable code for discriminating a recording medium type in a recording media drive, and more particularly, to an apparatus, method, and medium including computer readable code for discriminating a type of recording medium using a wobble amplitude on the recording medium.

2. Description of the Related Art

There are various types of recordable media, such as a recordable CD (compact disc) and a recordable DVD (digital versatile disc) media. The recordable DVDs can be divided into DVD−R/+R type discs, i.e., one-time recordable discs, and DVD−RW/DVD+RW type discs, i.e., re-recordable discs on which data can be recorded several times.

Although the shapes of the above-mentioned discs are the same, regardless of the types of the discs, their physical formats are different depending on the type of disc. That is, the recordable discs use periodic wobble grooves and utilize them to produce clock signals in a recording mode. The grooves are wobbled since the recordable discs cannot produce clock signals from reproduction signals. The clock signals can be used to control a rotation speed of the disc. However, the different types of recordable discs have different wobble frequencies and amplitudes. Further, methods of forming wobble grooves are different according to the type of recordable disc.

For example, while the wobble amplitude of a DVD−R/−RW disc is in the range of 7 to 14 nm, that of a DVD+R/+RW disc is in the range of 18 to 30 nm. In addition, while the wobble frequency of the DVD−R/−RW disc is 140 KHz, that of the DVD+R/+RW disc is 817 KHz. Further, while the wobble of the DVD−R/RW disc is formed such that an LPP (Land Pre Pit) is formed in a land area, that of the DVD+R/RW disc is formed using a phase modulation method.

Accordingly, operational conditions of a disc drive will vary depending on the type of disc in the disc drive. In order to drive various types of discs having different physical formats in the same disc drive, the disc drive must be able to set operational conditions of the disc drive to correspond to the physical format of a disc to be driven, during a lead-in time period of the disc. The setting of the operational conditions enables normal reading and/or writing of data from/to the disc. For example, the setting of a servo gain to stabilize servo operations is a setting of the operational conditions of the disc drive. However, in order to set the operational conditions, first the type of the disc to be driven must be correctly discriminated.

In a conventional method of discriminating a type of disc, the disc type is discriminated on the basis of an ID (identification) code recorded in a control data zone of the disc. That is, the disc type is discriminated by reading the ID code, after the operational conditions of the disc drive have been set, using the ID code recorded in the control data. In this manner, if it is then determined that the then currently set operational conditions are appropriate for the discriminated disc type, the lead-in operation for the disc is over.

However, if the operational conditions of the disc drive are not appropriate for the discriminated disc type, the disc driver must retry the setting of the operational conditions to correspond to the discriminated disc type. Accordingly, in the case where the operational conditions of the disc drive are not appropriate for the discriminated disc type, the performance of the lead-in operation becomes inefficient.

### SUMMARY OF THE INVENTION

Aspects and/or advantages of the present invention are accomplished by way of embodiments of the present invention, including an apparatus, method, and medium including computer readable code for discriminating a type of a recording medium based on an amplitude of a wobble groove formed on the recording medium. Further, embodiments of the present invention may also provide an apparatus, method, and medium including computer readable code for discriminating between a DVD(−) type disc and a DVD(+) type disc based on an amplitude of a wobble groove formed on the disc.

Additional aspects and/or advantages of the invention will be set forth in part in the description which follows and, in part, will be obvious from the description, or may be learned by practice of the invention.

According to an aspect of the present invention, there is provided a recording medium type discriminating apparatus, including a radio frequency (RF) amplifier to output a signal based on light reflected from a recording medium, a wobble amplitude detector to detect an amplitude of a wobble formed on the recording medium based on an output signal of the RF amplifier, and a system controller to discriminate a recording medium type of the recording medium by comparing the wobble amplitude with a reference value.

In addition, the system controller may determine that the recording medium is a DVD(+) type recording medium when the wobble amplitude is higher than the reference value and that the recording medium is a DVD(−) type recording medium when the wobble amplitude is not higher than the reference value.

According to another aspect of the present invention, there is provided a recording medium type discriminating apparatus, including a radio frequency (RF) amplifier to output a signal based on light reflected from the recording medium, an automatic gain controller (AGC) to control an amplitude gain of the output signal of the RF amplifier so that the output signal of the RF amplifier has a constant level, and a system controller to discriminate a recording medium type of recording medium by comparing a gain value used in the AGC with a reference value.

The system controller may monitor the gain value of the AGC and determine that the recording medium is a DVD(−) type recording medium when the gain value is higher than the reference value and that the recording medium is a DVD(+) type recording medium when the wobble amplitude is not higher than the reference value.

According to yet another aspect of the present invention, there is provided a recording medium type discriminating method, including detecting an amplitude of a wobble formed on a recording medium using light reflected from the recording medium, and discriminating a recording medium type of the recording medium by comparing the detected wobble amplitude with a reference value.

The discrimination of the recording medium type of the recording medium may include determining that the recording medium is a DVD(+) type recording medium when the amplitude of the wobble is higher than the reference value and that the recording medium is a DVD(−) type recording medium when the amplitude of the wobble is not higher than the reference value.

According to a further aspect of the present invention, there is provided a recording medium type discriminating method, including automatically controlling an amplitude gain value of a radio frequency (RF) signal detected using light reflected from a recording medium so that an amplitude of the RF signal has a constant level, and discriminating a recording medium type of the recording medium by comparing the amplitude gain value with a reference value.

The discrimination of the recording medium type of the recording medium may include monitoring the amplitude gain value and determining that the recording medium is a DVD(−) type recording medium when the gain value is higher than the reference value and that the recording medium is a DVD(+) type recording medium when the wobble amplitude is not higher than the reference value.

According to another aspect of the present invention, there is provided a medium including a computer readable code to control a computer to perform recording medium type discrimination, including at least detecting an amplitude of a wobble formed on a recording medium using light reflected from the recording medium, and discriminating a recording medium type of the recording medium by comparing the detected wobble amplitude with a reference value.

The discrimination of the recording medium type of the recording medium includes determining that the recording medium is a DVD(+) type recording medium when the amplitude of the wobble is higher than the reference value and that the recording medium is a DVD(−) type recording medium when the amplitude of the wobble is not higher than the reference value.

Lastly, according to another aspect of the present invention, there is provided a medium including a computer readable code to control a computer to perform recording medium type discrimination, including at least automatically controlling an amplitude gain value of a radio frequency (RF) signal detected using light reflected from a recording medium so that the amplitude of the RF signal can have a constant level, and discriminating a recording medium type of the recording medium by comparing the amplitude gain value with a reference value.

The discrimination of the recording medium type of the recording medium may include monitoring the amplitude gain value and determining that the recording medium is a DVD(−) type recording medium when the gain value is higher than the reference value and that the recording medium is a DVD(+) type recording medium when the wobble amplitude is not higher than the reference value.

### BRIEF DESCRIPTION OF THE DRAWINGS

These and/or other aspects and advantages of the present invention will become more apparent and more readily appreciated from the following embodiments, taken in conjunction with the accompanying drawings in which:

FIG. 1 is a block diagram of an embodiment of the present invention, including a disc drive apparatus, for discriminating a type of disc;

FIG. 2 shows an example of a wobble groove formed on a DVD;

FIG. 3 is a flowchart of a method for discriminating a type of disc according to an embodiment of the present invention;

FIG. 4 is a block diagram of another embodiment of the present invention, including a disc drive apparatus, for discriminating a type of disc; and

FIG. 5 is a flowchart of a method for discriminating a type of disc according to another embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below in order to explain the present invention by referring to the figures.

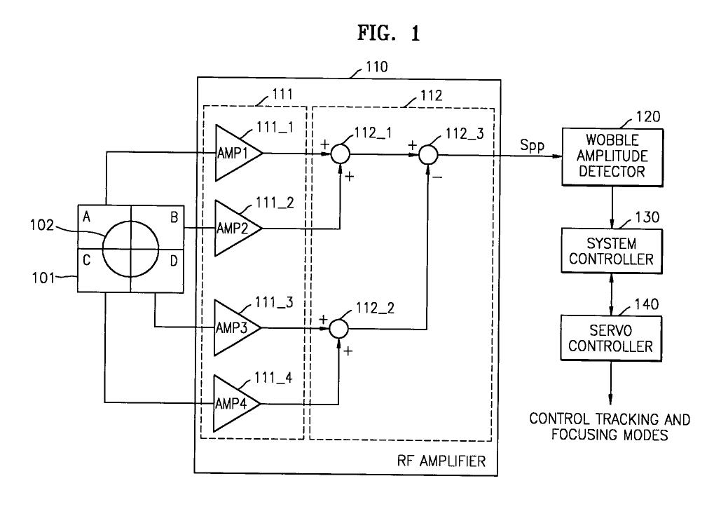

FIG. 1 is a block diagram of a disc drive including an apparatus for discriminating a type of disc according to an embodiment of the present invention. Referring to FIG. 1, the disc drive includes an optical detector 101, a radio frequency (RF) amplifier 110, a wobble amplitude detector 120, a system controller 130, and a servo controller 140.

The optical detector 101 is incorporated in a pickup (not shown) of the disc drive. The optical detector 101 detects light reflected from a disc (not shown). The optical detector 101 illustrated in FIG. 1 is divided into four sections, though the optical detector 101 could also have a different structure. For example, an optical detector having a bi-sectional structure could also be used as the optical detector 101. Reference number 102, in FIG. 1, references a spot formed by light reflected from the disc. As illustrated in FIG. 1, the optical detector 101 may be comprised of four photodiodes.

The RF amplifier 110 includes a current-to-voltage converter 111 and a push-pull operator 112. Since the optical detector 101 has a four-sectioned structure, the current-to-voltage converter 111 is comprised of four amplifiers 111_1 through 111_4. The amplifiers 111_1 through 111_4 convert output signals of corresponding photodiodes of the optical detector 101 to voltage values. That is, electrical signals output from a photodiode A are converted to voltage values through the amplifier 111_1, electrical signals output from a photodiode B are converted to voltage values through the amplifier 111_2, electrical signals output from a photodiode C are converted to voltage values through the amplifier 111_3, and electrical signals output from a photodiode D are converted to voltage values through the amplifier 111_4.

The push-pull operator 112 includes adders 112_1 and 112_2 and a subtracter 112_3. The adder 112_1 adds output signals of the amplifiers 111_1 and 111_2, the adder 112_2 adds output signals of the amplifiers 111_3 and 111_4, and the subtracter 112_3 subtracts an output signal of the adder 112_1 from an output signal of the adder 112_2. Through these calculating operations, a push-pull signal Spp corresponding to light output from the optical detector 102 is obtained.

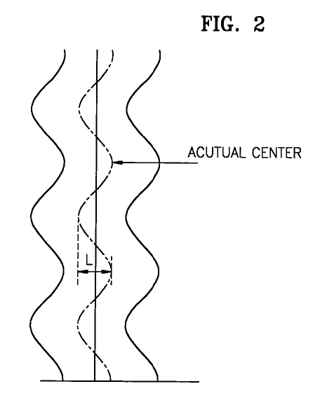

The wobble amplitude detector 120 detects a peak-to-peak value of the push-pull signal Spp output from the RF amplifier 110. In a case where a groove wobble is formed on a disc as shown in FIG. 2, the peak-to-peak value detected by the push-pull signal Spp corresponds to the peak-to-peak value “L”. The peak-to-peak value can be detected in a conventional method of detecting a peak-to-peak value of a sine wave. The detected wobble amplitude is then provided to the system controller 130.

The system controller 130 controls the disc drive to enable tracking and focusing modes via the servo controller 140 and, then, compares the wobble amplitude provided from the wobble amplitude detector 120 with a reference value. The reference value is determined in consideration of the facts that the wobble amplitude of a DVD−R/−RW disc is in the range of 7 to 14 nm and that of a DVD+R/+RW disc is in the range of 18 to 30 nm. As a result of the comparison, if the wobble amplitude is higher than the reference value, the system controller 130 determines that the disc inserted in the disc drive is a DVD(+) type disc. However, if the wobble amplitude is not higher than the reference value, the system controller 130 determines that the disc inserted in the disc drive is a DVD(−) type disc.

The servo controller 140 may control the focusing and tracking modes in a conventional way under the control of the system controller 130.

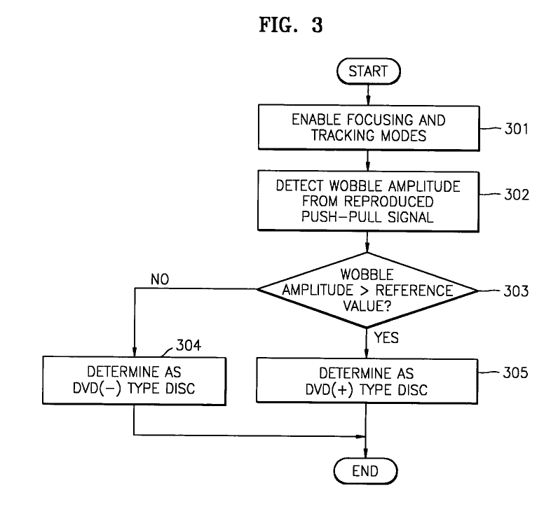

FIG. 3 is a flowchart of a method for discriminating a type of disc according to an embodiment of the present invention.

In operation 301, the system controller 130 enables tracking and focusing modes of the disc drive. The focusing and tracking modes are then controlled in a conventional way. In operation 302, the system controller 130 detects the wobble amplitude of the disc from the reproduced push-pull signal Spp.

In operation 303, the system controller 130 compares the detected wobble amplitude with the aforementioned reference value. The reference value is determined as described above, with reference to FIG. 1. If it is determined in operation 303 that the detected wobble amplitude is higher than the reference value, the system controller 130 determines in operation 305 that the disc inserted in the disc drive is a DVD(+) type disc.

However, if it is determined in operation 303 that the detected wobble amplitude is not higher than the reference value, the system controller 130 determines in operation 304 that the disc inserted into the disc drive is a DVD(−) type disc.

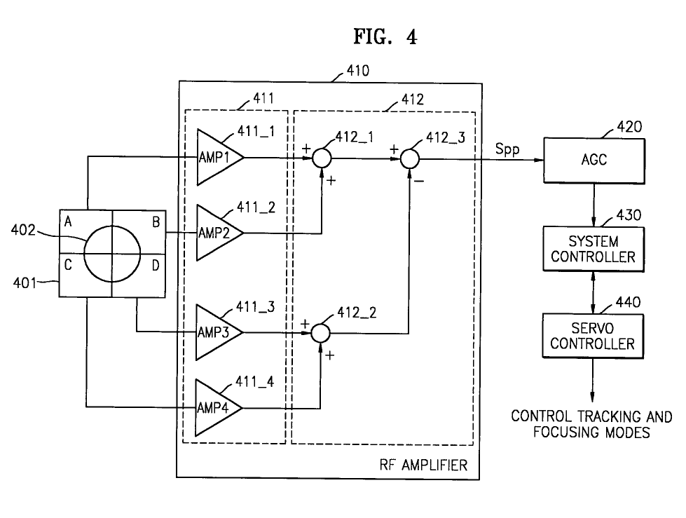

FIG. 4 is a block diagram of another embodiment of the present invention for discriminating a type of disc. Referring to FIG. 4, the disc drive includes an optical detector 401, an RF amplifier 410, an automatic gain controller (AGC) 420, a system controller 430, and a servo controller 440.

Descriptions on the optical detector 401, the RF amplifier 410, and the servo controller 440 are omitted below because they may be identical to the optical detector 101, the RF amplifier 110, and the servo controller 140, of FIG. 1, respectively.

The AGC 420 automatically controls an amplitude gain of the push-pull signal Spp output from the RF amplifier 410 so that the push-pull signal Spp has a predetermined constant amplitude level. The AGC 420 may be a well-known AGC circuit.

The system controller 130 controls the disc drive to enable tracking and focusing modes via the servo controller 140 and monitors the amplitude gain value of the AGC 420. The value of the output signal level of the AGC 420 is provided from the system controller 430.

Then, the system controller 430 compares the amplitude gain value of the AGC 430 detected by monitoring the AGC 430 with another reference value. The reference value is determined in consideration of the facts that the wobble amplitude of a DVD−R/−RW disc is in the range of 7 to 14 nm and that of a DVD+R/+RW disc is in the range of 18 to 30 nm, i.e., the reference value is about 16 nm, or approximately 14-18 nm. That is, the reference value is based on an estimated amplitude gain value to which the amplitude of the push-pull signal, produced on the basis of the above-described wobble amplitudes, is constantly adjusted.

If the amplitude gain value is higher than the reference value, the system controller 430 determines that the disc (not shown) inserted into the disc drive is a DVD(−) type disc. On the other hand, if the amplitude gain value is not higher than the reference value, the system controller 430 determines that the disc (not shown) is a DVD( +) type disc.

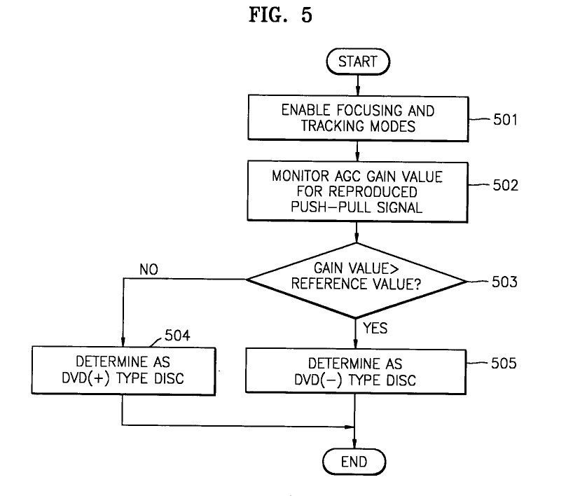

FIG. 5 is a flowchart of a method for discriminating a type of disc according to another embodiment of the present invention.

In operation 501, the system controller 430 enables tracking and focusing modes of the disc drive. The focusing and tracking modes may be controlled in a conventional way. In operation 502, the system controller 430 detects the gain value used in automatically adjusting the gain of the reproduced push-pull signal.

In operation 503, the system controller 430 compares the detected gain value with the aforementioned reference value. If it is determined in operation 503 that the detected gain value is higher than the reference value, then the system controller 430 determines, in operation 505, that the disc inserted in the disc drive is a DVD(−) type disc.

However, if it is determined in operation 503 that the detected gain value is not higher than the reference value, then the system controller 430 determines, in operation 504, that the disc inserted into the disc drive is a DVD(+) type disc.

As described above, according to embodiments of the present invention, it is possible to simply discriminate a disc type based on a groove wobble amplitude of a disc in the early stage of a disc driving period, i.e., immediately after controlling a tracking servo. Accordingly, operational conditions of a disc drive can be set in the early stage of the disc driving period and, thus, lead-in time of a disc can be reduced.

Further, embodiments of the present invention may be controlled by a general purpose digital computer, or computers, by running computer readable code from a medium, including but not limited to storage media such as magnetic storage media (e.g., ROMs, floppy discs hard discs, etc.), optically readable media (e.g., CD-ROMs, DVDs, etc.), carrier waves (e.g., transmissions over the Internet), and electrical wave guides. The medium may also be dispersively installed in a computer system connected to a network, and stored and executed as a computer readable code by a distributed computing environment.

While the present invention has been particularly shown and described with reference to preferred embodiments thereof, it will be understood by those of ordinary skill in the art that various changes in form and details may be made therein without departing from the spirit and scope of the present invention, as defined by the claims and their equivalents.

What is claimed is:

1. A recording medium type discriminating apparatus, comprising:
a radio frequency (RF) amplifier to output a signal based on light reflected from a recording medium;
a wobble amplitude detector to detect an amplitude of a wobble formed on the recording medium based on an output signal of the RF amplifier; and
a system controller to discriminate a recording medium type of the recording medium by comparing the wobble amplitude with a reference value.

2. The apparatus of claim 1, wherein the RF amplifier detects a push-pull signal by determining an amount of the reflected light and provides the detected push-pull signal to the wobble amplitude detector.

3. The apparatus of claim 2, wherein the wobble amplitude detector detects a peak-to-peak value of the output signal of the RF amplifier and identifies the detected peak-to-peak value as the wobble amplitude.

4. The apparatus of claim 1, wherein the wobble amplitude detector detects a peak-to-peak value of the output signal of the RF amplifier and identifies the detected peak-to-peak value as the wobble amplitude.

5. The apparatus of claim 1, wherein the system controller determines that the recording medium is a DVD(+) type recording medium when the wobble amplitude is higher than the reference value and that the recording medium is a DVD(−) type recording medium when the wobble amplitude is not higher than the reference value.

6. The apparatus of claim 1, wherein the reference value is about 16 nm.

7. The apparatus of claim 1, wherein the reference value is less than 18 nm.

8. The apparatus of claim 1, wherein the reference value is greater than 14 nm.

9. A recording medium type discriminating apparatus, comprising:
a radio frequency (RF) amplifier to output a signal based on light reflected from the recording medium;
an automatic gain controller (AGC) to control an amplitude gain of the output signal of the RF amplifier so that the output signal of the RF amplifier has a constant level; and
a system controller to discriminate a recording medium type of recording medium by comparing a gain value used in the AGC with a reference value.

10. The apparatus of claim 9, wherein the RF amplifier detects a push-pull signal by determining an amount of the reflected light and provides the detected push-pull signal to the AGC.

11. The apparatus of claim 9, wherein the system controller monitors the gain value of the AGC and determines that the recording medium is a DVD(−) type recording medium when the gain value is higher than the reference value and that the recording medium is a DVD(+) type recording medium when the wobble amplitude is not higher than the reference value.

12. The apparatus of claim 9, wherein the reference value is about 16 nm.

13. The apparatus of claim 9, wherein the reference value is less than 18 nm.

14. The apparatus of claim 9, wherein the reference value is greater than 14 nm.

15. A recording medium type discriminating method, comprising:
detecting an amplitude of a wobble formed on a recording medium using light reflected from the recording medium; and
discriminating a recording medium type of the recording medium by comparing the detected wobble amplitude with a reference value.

16. The method of claim 15, wherein the discrimination of the recording medium type of the recording medium includes determining that the recording medium is a DVD(+) type recording medium when the amplitude of the wobble is higher than the reference value and that the recording medium is a DVD(−) type recording medium when the amplitude of the wobble is not higher than the reference value.

17. The method of claim 16, wherein the detection of the amplitude of the wobble includes detecting a peak-to-peak value of a detected RF (radio frequency) signal, corresponding to an amount of light reflected from the recording medium, and identifying the amplitude of the wobble as being the peak-to-peak value.

18. The method of claim 15, wherein the detection of the amplitude of the wobble includes detecting a peak-to-peak value of a detected radio frequency (RF) signal, corresponding to an amount of light reflected from the recording medium, and identifying the amplitude of the wobble as being the peak-to-peak value.

19. The method of claim 15, wherein the reference value is about 16 nm.

20. The method of claim 15, wherein the reference value is less than 18 nm.

21. The method of claim 15, wherein the reference value is greater than 14 nm.

22. A recording medium type discriminating method, comprising:
automatically controlling an amplitude gain value of a radio frequency (RF) signal detected using light reflected from a recording medium so that an amplitude of the RF signal has a constant level; and
discriminating a recording medium type of the recording medium by comparing the amplitude gain value with a reference value.

23. The method of claim 22, wherein the discrimination of the recording medium type of the recording medium includes monitoring the amplitude gain value and determining that the recording medium is a DVD(−) type recording medium when the gain value is higher than the reference value and that the recording medium is a DVD(+) type recording medium when the wobble amplitude is not higher than the reference value.

24. The method of claim 22, wherein the reference value is about 16 nm.

25. The method of claim 22, wherein the reference value is less than 18 nm.

26. The method of claim 22, wherein the reference value is greater than 14 nm.

27. A medium comprising a computer readable code to control a computer to perform recording medium type discrimination, including at least:
detecting an amplitude of a wobble formed on a recording medium using light reflected from the recording medium; and
discriminating a recording medium type of the recording medium by comparing the detected wobble amplitude with a reference value.

28. The medium of claim 27, wherein the discrimination of the recording medium type of the recording medium includes determining that the recording medium is a DVD(+) type recording medium when the amplitude of the wobble is higher than the reference value and that the recording medium is a DVD(−) type recording medium when the amplitude of the wobble is not higher than the reference value.

29. The medium of claim 28, wherein the detection of the amplitude of the wobble includes detecting a peak-to-peak value of a detected RF (radio frequency) signal, corresponding to an amount of light reflected from the recording medium, and identifying the amplitude of the wobble as being the peak-to-peak value.

30. The medium of claim 27, wherein the detection of the amplitude of the wobble includes detecting a peak-to-peak value of a detected radio frequency (RF) signal, corresponding to an amount of light reflected from the recording medium, and identifying the amplitude of the wobble as being the peak-to-peak value.

31. The medium of claim 27, wherein the reference value is about 16 nm.

32. The medium of claim 27, wherein the reference value is less than 18 nm.

33. The medium of claim 27, wherein the reference value is greater than 14 nm.

34. A medium comprising a computer readable code to control a computer to perform recording medium type discrimination, including at least:
automatically controlling an amplitude gain value of a radio frequency (RF) signal detected using light reflected from a recording medium so that the amplitude of the RF signal can have a constant level; and
discriminating a recording medium type of the recording medium by comparing the amplitude gain value with a reference value.

35. The medium of claim 34, wherein the discrimination of the recording medium type of the recording medium includes monitoring the amplitude gain value and determining that the recording medium is a DVD(−) type recording medium when the gain value is higher than the reference value and that the recording medium is a DVD(+) type recording medium when the wobble amplitude is not higher than the reference value.

36. The medium of claim 34, wherein the reference value is about 16 nm.

37. The medium of claim 34, wherein the reference value is less than 18 nm.

38. The medium of claim 34, wherein the reference value is greater than 14 nm.
